(19) United States
(12) Patent Application Publication
(10) Pub. No.: US 2010/0050268 A1
(43) Pub. Date: Feb. 25, 2010

(54) PASSWORD PROTECTION SYSTEM AND METHOD

(75) Inventor: Victor I. Sheymov, Vienna, VA (US)

Correspondence Address: ROBERTS MLOTKOWSKI SAFRAN & COLE, P.C.;Intellectual Property Department, P.O. Box 10064, MCLEAN, VA, 22102-8064, US

(73) Assignee: Invicta Networks Inc., Reston, VA (US)

(21) Appl. No.: 12/527,791

(22) PCT Filed: Feb. 21, 2008
(86) PCT No.: PCT/US08/54503

§ 371 Date: Aug. 19, 2009

Related U.S. Application Data
(60) Provisional application No. 60/902,357, filed on Feb. 21, 2007.

(51) Int. Cl. G06F 21/00

(52) U.S. Cl. 726/27

(57) ABSTRACT

A method, system, and device for password protection for a computer or other electronic device are provided, including providing one or more false passwords that outwardly cause the computer or other electronic device to behave as if a correct password was entered and that inwardly cause the computer or other electronic device to behave differently than as if the correct password was entered; and taking a predetermined action when one of the false passwords is entered.

### CROSS REFERENCE TO RELATED DOCUMENTS

The present invention claims benefit of priority to U.S. Provisional Patent Application Ser. No. 60/902,357 of Sheymov, entitled “PASSWORD PROTECTION SYSTEM AND METHOD,” filed on Feb. 21, 2007, the entire disclosure of which is hereby incorporated by reference herein.

### BACKGROUND OF THE INVENTION

1. Field of the Invention

The present invention generally relates to system and methods for protecting computers, and more particularly to a system and method for password protection for computers and other electronic devices.

2. Discussion of the Background

During last several decades, proliferation of computers and other computing and communicating electronic devices naturally led to a need for development of effective security systems that would guard against their unauthorized access and use. One of such areas of security is access to computers and other electronic devices. This area became particularly relevant with the wide popularity of portable devices, such as notebook computers, cellular phones, and the like, with their decreased size and increased vulnerability to theft.

Legacy attempts to secure access to such devices by using a password of some sort have not been particularly successful. For example, computing power has reached such a stage where “cracking the password” or solving a crypto protection mechanism of the password has become a relatively easy task for even an average computer. A wide variety of such “password cracking” computer programs are readily available on the Internet, and often for free. This has led to the common opinion that password protection is not effective.

A logical shift under such circumstances is to employ “token” type of protection schemes, and the like. While such protection schemes are more effective than a password, the cryptographic robustness of such schemes also may come to scrutiny in near future, given the ever increasing computing power of the opposing attacker computers. Also, “token” devices are subject to theft as well, making their overall effectiveness less than perfect.

Another approach gaining popularity is the use of a variety of biometric devices. This technological direction is being developed rapidly. However, simultaneously with the development of sophisticated biometric devices, the technology for the counterfeiting of such devices is automatically developed, and is a trend that has been observed over a long period of time with devices for the counterfeiting paper money.

All of the above indicates that there is a need for a reliable, i.e., cryptographically robust and difficult to steal, relatively low cost mechanism for securing access to computers and other electronic devices.

### SUMMARY OF THE INVENTION

Therefore, there is a need for a method, system, and device that address the above and other problems with computers and other electronic devices. The above and other needs are addressed by the exemplary embodiments of the present invention, which provide a method, system, and device for password protection for computers and other electronic devices.

Accordingly, in exemplary aspects of the present invention, a method, system, and device for password protection for a computer or electronic device are provided, including providing one or more false passwords that outwardly cause the computer or electronic device to behave as if a correct password was entered and that inwardly cause the computer or electronic device to behave differently than as if the correct password was entered; and taking a predetermined action when one of the false passwords is entered. The predetermined action includes sending a message over a communications network to an authority. The authority includes one of a security base, and police. The predetermined action includes one of hiding sensitive files, deleting sensitive files, and electronically self-destructing the computer or electronic device.

Still other aspects, features, and advantages of the present invention are readily apparent from the following detailed description, simply by illustrating a number of exemplary embodiments and implementations, including the best mode contemplated for carrying out the present invention. The present invention also is capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings, in which like reference numerals refer to similar elements, and in which:

FIG. 1 illustrates a password used to protect access to a computer through its keyboard for describing the exemplary embodiments;

FIG. 2 illustrates an exemplary password protection scheme for computers and other electronic devices; and

FIG. 3 illustrates an exemplary flowchart for password protection for computers and other electronic devices.

### DETAILED DESCRIPTION OF THE PREFERRED EMBODIMENTS

An improved method, system, and device for password protection of computers and other electronic devices are described. In the following description, for purposes of explanation, numerous specific details are set forth in order to provide a thorough understanding of the present invention. It is apparent to one skilled in the art, however, that the present invention can be practiced without these specific details or with an equivalent arrangement. In some instances, well-known structures and devices are shown in block diagram form in order to avoid unnecessarily obscuring the present invention.

The present invention includes recognition that robustness assessment of cryptographic systems concentrates on the level of entropy in a given system. Traditionally, some variables used in the assessment are often set constant for simplification of the assessment. For example, the number of allowed attempts to resolve the crypto algorithm is often considered unlimited. The criteria of success are usually assumed to be absolutely definite. This means that an attacker definitely knows if he succeeded or not in every attempt.

These assumptions, while generally reasonably valid for traditional crypto systems, may not be universally valid for all systems. Furthermore, these parameters may be held as variable and additional entropy can be introduced into the system through randomizing them.

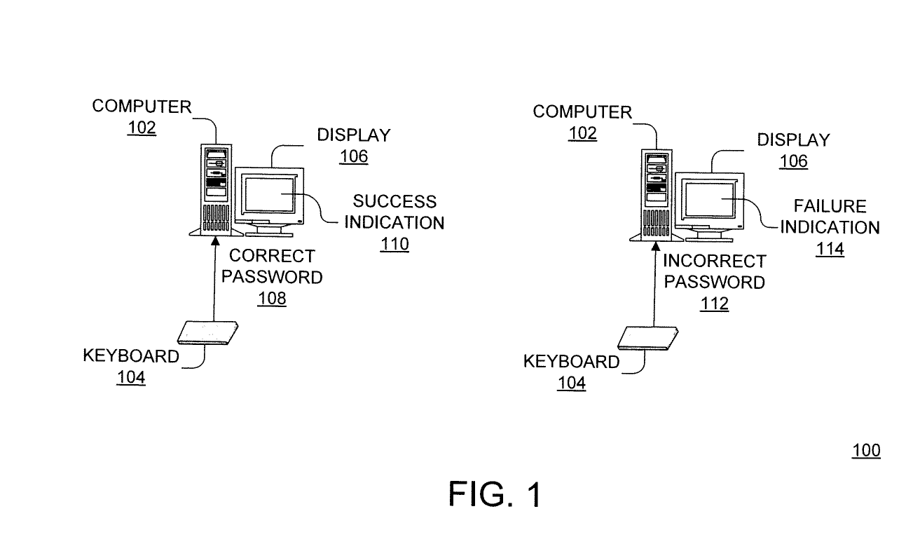

Referring now to the drawings, FIGS. 1-3 thereof illustrate an exemplary password protection scheme for addressing the above and other problems with computer and other electronic devices. In FIG. 1, a practical example of a system 100 employing a password used to protect access to a computer 102 through its keyboard 104 is illustrated. A password itself has a relatively low entropy level and can be “guessed” through a limited number of tries. However, an interesting element in the process is that an attacker immediately knows if he succeeded or not with a password by looking at the screen or display 106 of the computer 102. In the case of success or entering a correct password 108, the attacker would observe a success indication 110, such as the computer 102 waking up, providing a greeting, etc. In the case of failure or entering an incorrect password 112, the attacker would get a failure indication 114, such as an access denial notice or nothing at all, which is also definitive. In other words, in either case, definite criteria of success are available to the attacker.

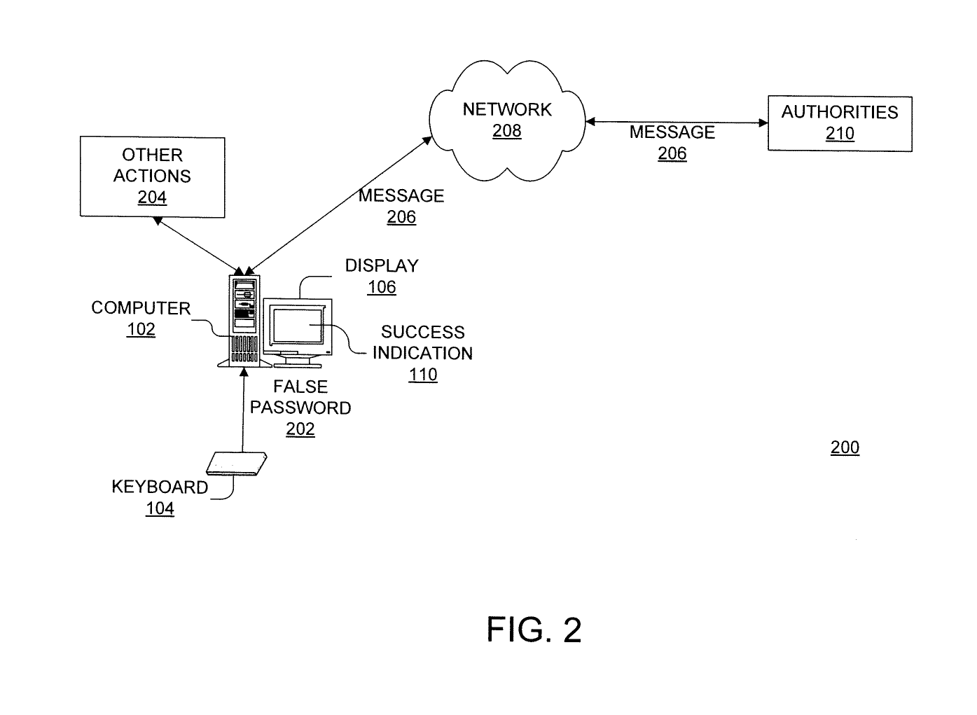

FIG. 2 illustrates an exemplary password protection scheme and system 200 for computers and other electronic devices. In FIG. 2, the exemplary system 200 can include various mechanisms. For example, one mechanism is to deny an attacker definite criteria of success. This can be done, for example, by introducing “false passwords” 202. Then, when one of these false passwords 202 is keyed in or entered, the computer 102 starts to outwardly behave exactly like when a right or correct password is keyed in or entered, for example, with a success indication 110, as previously described. Another mechanism is that inwardly (e.g., invisible to the attacker) the computer 102 can behave totally differently, reacting to the recognized attack by one or more pre-programmed actions 204, such as sending messages 206 over a communications network 208 to the authorities 210, such as “security base,” or police, or by hiding or deleting sensitive files, etc., or even electronically self-destructing the computer 102 via any known means, thus defeating the attacker's goal. Advantageously, such a response has a better chance of success, when it is masked by such a “false acceptance” 110 of the false password 202.

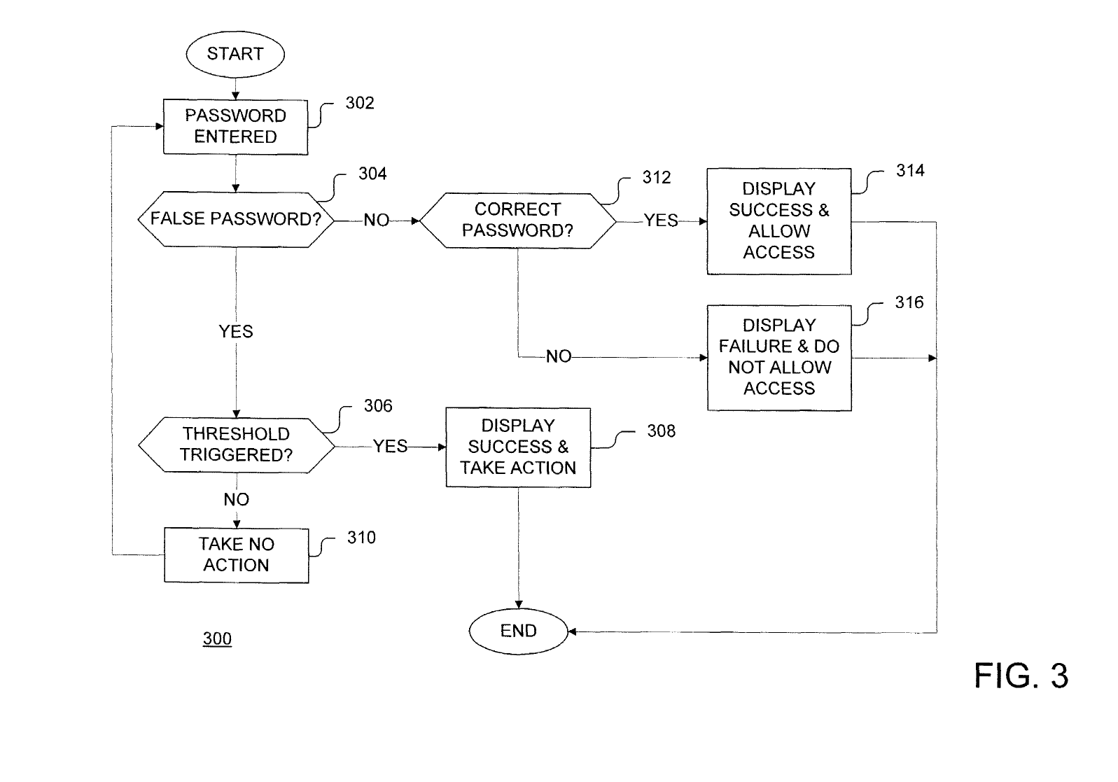

With this approach, additional entropy is introduced through a number of “false success” signals. Accordingly, FIG. 3 illustrates an exemplary flowchart 300 for password protection for computers and other electronic devices. In FIG. 3, the triggering criteria or threshold of such a defensive mechanism could be different too. For example, it could be quite deterministic, such as a definite number of false passwords entered by the attacker, or it could be a random number (e.g., within range) of the false passwords entered by the attacker. Also, it could be a certain number of false passwords pre-programmed into the system (e.g., deterministic or random), and when any of these passwords are entered by the attacker, it can trigger a defensive mechanism or action. In FIG. 3, processing begins at step 302 where the password is entered. At step 304, it is determined if the entered password is false, and if so at step 306 it is determined if the threshold has been triggered, and if so at step 308 success is displayed and an appropriate action is taken, completing the process. If the threshold has not been triggered, no action is taken at step 310 and control returns to step 302. If a false password has not been entered, as determined at step 304, at step 312 it is determined if the correct password has been entered, and if so at step 314 success is displayed and access is allowed to the computer, completing the process. If the correct password has not been entered, at step 316 failure is displayed and access is not allowed to the computer, completing the process.

One example of an application of the exemplary security system of FIGS. 1-3 is for protecting a GPS equipped mobile phone. In this case, a response to a false password could be a call to the police with an alarm and the GPS coordinates of the phone. Furthermore, the phone (or, e.g., another communications capable device) can transmit signals on specific frequencies to increase accuracy of identifying its position with an appropriate antenna by a responding party, and the like.

The above-described devices and subsystems of the exemplary embodiments of FIGS. 1-3 can include, for example, any suitable servers, workstations, PCs, laptop computers, PDAs, Internet appliances, handheld devices, cellular telephones, wireless devices, other electronic devices, and the like, capable of performing the processes of the exemplary embodiments of FIGS. 1-3. The devices and subsystems of the exemplary embodiments of FIGS. 1-3 can communicate with each other using any suitable protocol and can be implemented using one or more programmed computer systems or devices.

One or more interface mechanisms can be used with the exemplary embodiments of FIGS. 1-3, including, for example, Internet access, telecommunications in any suitable form (e.g., voice, modem, and the like), wireless communications media, and the like. For example, the employed communications networks can include one or more wireless communications networks, cellular communications networks, 3G communications networks, Public Switched Telephone Network (PSTNs), Packet Data Networks (PDNs), the Internet, intranets, a combination thereof, and the like.

It is to be understood that the devices and subsystems of the exemplary embodiments of FIGS. 1-3 are for exemplary purposes, as many variations of the specific hardware and/or software used to implement the exemplary embodiments are possible, as will be appreciated by those skilled in the relevant art(s). For example, the functionality of one or more of the devices and subsystems of the exemplary embodiments of FIGS. 1-3 can be implemented via one or more programmed computer systems or devices.

To implement such variations as well as other variations, a single computer system can be programmed to perform the special purpose functions of one or more of the devices and subsystems of the exemplary embodiments of FIGS. 1-3. On the other hand, two or more programmed computer systems or devices can be substituted for any one of the devices and subsystems of the exemplary embodiments of FIGS. 1-3. Accordingly, principles and advantages of distributed processing, such as redundancy, replication, and the like, also can be implemented, as desired, to increase the robustness and performance the devices and subsystems of the exemplary embodiments of FIGS. 1-3.

The devices and subsystems of the exemplary embodiments of FIGS. 1-3 can store information relating to various processes described herein. This information can be stored in one or more memories, such as a hard disk, optical disk, magneto-optical disk, RAM, and the like, of the devices and subsystems of the exemplary embodiments of FIGS. 1-3. One or more databases of the devices and subsystems of the exemplary embodiments of FIGS. 1-3 can store the information used to implement the exemplary embodiments of the present invention. The databases can be organized using data structures (e.g., records, tables, arrays, fields, graphs, trees, lists, and the like) included in one or more memories or storage devices listed herein. The processes described with respect to the exemplary embodiments of FIGS. 1-3 can include appropriate data structures for storing data collected and/or generated by the processes of the devices and subsystems of the exemplary embodiments of FIGS. 1-3 in one or more databases thereof.

All or a portion of the devices and subsystems of the exemplary embodiments of FIGS. 1-3 can be conveniently implemented using one or more general purpose computer systems, microprocessors, digital signal processors, micro-controllers, and the like, programmed according to the teachings of the exemplary embodiments of the present invention, as will be appreciated by those skilled in the computer and software arts. Appropriate software can be readily prepared by programmers of ordinary skill based on the teachings of the exemplary embodiments, as will be appreciated by those skilled in the software art. In addition, the devices and subsystems of the exemplary embodiments of FIGS. 1-3 can be implemented by the preparation of application-specific integrated circuits or by interconnecting an appropriate network of conventional component circuits, as will be appreciated by those skilled in the electrical art(s). Thus, the exemplary embodiments are not limited to any specific combination of hardware circuitry and/or software.

Stored on any one or on a combination of computer readable media, the exemplary embodiments of the present invention can include software for controlling the devices and subsystems of the exemplary embodiments of FIGS. 1-3, for driving the devices and subsystems of the exemplary embodiments of FIGS. 1-3, for enabling the devices and subsystems of the exemplary embodiments of FIGS. 1-3 to interact with a human user, and the like. Such software can include, but is not limited to, device drivers, firmware, operating systems, development tools, applications software, and the like. Such computer readable media further can include the computer program product of an embodiment of the present invention for performing all or a portion (if processing is distributed) of the processing performed in implementing the exemplary embodiments of FIGS. 1-3. Computer code devices of the exemplary embodiments of the present invention can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the exemplary embodiments of the present invention can be distributed for better performance, reliability, cost, and the like.

As stated above, the devices and subsystems of the exemplary embodiments of FIGS. 1-3 can include computer readable medium or memories for holding instructions programmed according to the teachings of the present invention and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave, or any other suitable medium from which a computer can read.

While the present invention have been described in connection with a number of exemplary embodiments and implementations, the present invention is not so limited, but rather covers various modifications and equivalent arrangements, which fall within the purview of the appended claims.

1. A password protection method for a computer or electronic device, the method comprising:
providing one or more false passwords, unknown to an authorized user and attacker of the computer or electronic device, and that outwardly cause the computer or electronic device to behave as if a correct password, known to the authorized user and unknown to the attacker of the computer or electronic device, was entered and that inwardly cause the computer or electronic device to behave differently than as if the correct password was entered; and
taking a predetermined action when one of the false passwords is entered.

2. The method of claim 1, wherein the predetermined action includes sending a message over a communications network to an authority.

3. The method of claim 2, wherein the authority includes one of a security base, and police.

4. The method of claim 1, wherein the predetermined action includes one of hiding sensitive files, deleting sensitive files, and electronically self-destructing the computer or electronic device.

5. A computer program product for password protection for a computer or electronic device, and including one or more computer-readable instructions embedded on a computer-readable medium and configured to cause one or more computer processors to perform the steps of:
providing one or more false passwords, unknown to an authorized user and attacker of the computer or electronic device, and that outwardly cause the computer or electronic device to behave as if a correct password, known to the authorized user and unknown to the attacker of the computer or electronic device, was entered and that inwardly cause the computer or electronic device to behave differently than as if the correct password was entered; and
taking a predetermined action when one of the false passwords is entered.

6. The computer program product of claim 5, wherein the predetermined action includes sending a message over a communications network to an authority.

7. The computer program product of claim 6, wherein the authority includes one of a security base, and police.

8. The computer program product of claim 5, wherein the predetermined action includes one of hiding sensitive files, deleting sensitive files, and electronically self-destructing the computer or electronic device.

9. A computer-implemented system for password protection for a computer or electronic device, the system comprising:
means for providing one or more false passwords, unknown to an authorized user and attacker of the computer or electronic device, and that outwardly cause the computer or electronic device to behave as if a correct password, known to the authorized user and unknown to the attacker of the computer or electronic device, was entered and that inwardly cause the computer or electronic device to behave differently than as if the correct password was entered; and
means for taking a predetermined action when one of the false passwords is entered.

10. The system of claim 9, wherein the predetermined action includes sending a message over a communications network to an authority.

11. The system of claim 10, wherein the authority includes one of a security base, and police.

12. The system of claim 9, wherein the predetermined action includes one of means for hiding sensitive files, means for deleting sensitive files, and means for electronically self-destructing the computer or electronic device.
